(19) United States
(12) Patent Application Publication
(10) Pub. No.: US 2007/0144663 A1
(43) Pub. Date: Jun. 28, 2007

(54) Process for manufacture of oriented strand lumber products

(75) Inventors: Joel Barker, Townville, SC (US); Feipeng Liu, Statham, GA (US); Jianhua Pu, Bishop, GA (US)

Correspondence Address: Huber Engineered Woods L.L.C.;c/o J.M. Huber Corporation, Law Department, 333 Thornall Street, Edison, NJ, 08837-2220, US

(73) Assignee: Huber Engineered Woods L.L.C., Charlotte, NC (US)

(21) Appl. No.: 11/315,229

(22) Filed: Dec. 23, 2005

(51) Int. Cl. B32B 37/00

(52) U.S. Cl. 156/256

(57) ABSTRACT

The present teachings are directed toward a process for the production of engineered wood products, or oriented strand wood products, having certain desired or predetermined properties by selection of the strands used in the products. The present teachings provide a process which has enhanced utilization of wood resources, reduced product variability, and can produce engineered wood product of various grades and properties on the same production line.

### BACKGROUND

1. Field of the Invention

The present teachings generally relate to a process for the production of engineered wood products, or oriented strand wood products, having certain desired or predetermined properties by selection of the strand used in the products. The present teachings provide a process which has enhanced utilization of wood resources, reduced product variability, and can produce engineered wood product of various grades and properties on the same production line.

2. Discussion of the Related Art

Oriented strand board (“OSB”), oriented strand lumber (“OSL”) and laminated strand lumber (“LSL”) have been widely used as structural components for roof, wall, and sub-flooring assemblies in residential and commercial applications.

OSB is commercially available from a number of companies including Huber Engineered Woods LLC, Georgia-Pacific Corporation, Louisiana-Pacific Corporation and a number of other sources. This material has multiple layers of wood “strands” or “flakes” bonded together by a binding material such as phenol-formaldehyde resin or isocyanate resin together with sizing agents such as paraffinic waxes. The strands are made by cutting thin slices with a knife edge parallel to the length of a debarked log. The strands are typically 0.01 to 0.05 inches thick, although thinner and thicker strands can be used in some applications, and are typically, less than one inch to several inches long and less than one inch to a few inches wide. The strands typically are longer than they are wide, with aspect ratios (length:width) typically greater than about three. Strands are screened into different components and separated into storage bins. Strands sized less than about ⅛″, in general, are discarded and utilized as fuel. In general, 95-98% of wood resource can be utilized for making oriented strand boards.

In the fabrication of oriented strand board, the strands are first dried to remove water, and are then coated with a thin layer of binder and sizing agent. The coated strands are then spread on a conveyor belt in a series of alternating layers, where one layer will have the strands oriented generally in line with the conveyor belt, and the succeeding layer of strands oriented generally perpendicular to the conveyor belt, such that alternating layers have strands oriented generally perpendicular to one another. The word “strand” is used to signify the cellulosic fibers which make up the wood, and, because the grain of the wood runs the length of the wood particle, the “strands” in the oriented strand board are oriented generally perpendicular to each other in alternating layers. The layers of oriented “strands” or “flakes” are finally subjected to heat and pressure to fuse the strands and binder together. The resulting product is then cut to size and shipped. Typically, the resin and sizing agent comprise less than 10% by weight of the oriented strand board product.

The fabrication of oriented strand board is described in, for instance, U.S. Pat. No. 5,525,394 to Clarke et al., and another detailed description of OSB manufacturing process can be found in Engineered Wood Products—A Guide for Specifiers, Designers and Users, edited by Stephen Smulski, (1997). Additional processes for producing engineered wood products, such as OSB and OSL, include those generally described in U.S. Pat. Nos. 4,061,819; Re. 30,636; 4,364,984; 4,610,913; 4,715,131; 5,096,765; 5,740,898; and 6,263,773 B1. Oriented strand board has been used as sheathing for roofs, walls, subfloors and web for wooden I-beams, and in locations where strength, light weight, ease of nailing and dimensional stability under varying moisture conditions are important attributes. Oriented strand board is typically sold at a substantial discount compared to structural grade soft plywood.

Increasingly scarce lumber resources and increased housing demand have created great demands in the construction industry to replace traditional timber log products with engineered wood lumber products such as OSB, OSL, LSL and laminated veneer lumbers (“LVL”). Stronger and more durable products tailored to meet specific performance requirements of engineered wood composites are also in demand. An important mechanical property required in a structural component is the modulus of elasticity (“MOE”). Typically, for OSB, the MOE value is between about 0.45 to about 1.15 (mmpsi) along the major panel axis and is between about 0.08 to 0.49 (mmpsi) across the major panel axis. For I-joist components, the typical minimum MOE is about 1.50 (mmpsi). For short span header and beam applications, a minimum MOE value is around 1.30 (mmpsi). For railroad ties, the required MOE value is equal to or greater than about 1.80 (mmpsi).

In response to the diminishing availability of larger diameter sawn logs and the increasing supply of smaller diameter logs from juvenile woods, many manufacturing processes have been developed in the past which try to address the problems associated with this natural variation. Typical approaches include screening and controlling the strand orientation by using longer and larger strands (U.S. Pat. Nos. 4,061,819; 4,610,913; 4,751,131, and 5,096,765), cutting the strands into uniform width for better alignment (U.S. Pat. No. 6,039,910), and thinner strands to manufacture high-performance oriented strand composites (Zhang, et al., J. Wood Sci., Vol. 44, pp. 191-197 (1998)).

There are various factors affecting the properties of engineered wood based composites. The major controlling factors include raw material selection and manufacturing process. Known production processes typically simply process tree logs in whole to produce the end product with relatively little control over the natural variability of natural products such as tree logs. This variability in the raw material results in waste of the raw material to achieve engineering requirements of the final products. Thus it would be desirable to improve such a process by incorporating additional control to compensate for any potential quality deviations in the feedstock.

### SUMMARY

The present teachings satisfy the need for a process for the production of engineered wood products having certain desired properties by controlling the log selection and strand sizing or dimension control processes to fulfill the material requirements of the engineered wood product with the desired properties.

The present teachings provide a process for the production of an engineered wood product having certain desired properties by providing logs, sorting logs dependent on their properties into N piles of sorted logs, and cutting logs from at least one of the piles of sorted logs into strands. The strands produced from each log cutting operation, are then separately sorted dependent on strand properties into S groups of strands. Then either the strands from one or more groups are combined dependent on the desired properties of the resulting engineered wood product to form combined strands to which resin is applied to form resinated combined strands, or resin is applied to strands from one or more groups of strands to form resinated strands, and then the resinated strands are combined dependent on the desired properties of the resulting engineered wood product to form resinated combined strands. In either case, the resinated combined strands are oriented into mats; which are finished into an engineered wood product having the desired properties. In the process, N can be two or more, S can be two or more, and strands originating from different piles of sorted logs can be combined together to form the final engineered wood product.

According to the present teachings, the engineered wood products having different desired properties can be produced on the same engineered wood product production line.

### BRIEF DESCRIPTION OF THE FIGURES

The accompanying figures, which are included to provide a further understanding of the present teachings and are incorporated in and constitute a part of this specification, illustrate results obtained by various embodiments of the present teachings and together with the detailed description serve to explain the principles of the present teachings. In the figures:

FIG. 1 is a schematic of process according to the present teachings with a strand handling and control system.

### DETAILED DESCRIPTION

The present teachings relate to a process for the production of engineered wood products having certain desired properties by controlling the log selection and strand size control and selection processes to fulfill the material requirements of the engineered wood product with the desired properties.

According to the present teachings, strands generally used for surface layers with specifically defined sizes can be utilized to make engineered wood products that can meet the stiffness requirement of an MOE greater than about 1.30 (mmpsi) for I-joist flanges, headers and beams for residential market. Use of a standard OSB production line to make, for example, both LSL products and OSB products, dependent upon the strand qualities and actual manufacturing processing capacities, is provided by present teachings. Although short strands can generally not be used for making LSL products, these strands can be acceptable raw material for making OSB, and the various embodiments of the present teachings provide processes to produce both LSL and OSB from the same initial log source. Thus, the problem of using a standard OSB process to make acceptable LSL, which screen out and discard about 50-70% of strands is addressed by the various embodiments of the present teachings.

A process according to the present teachings is provided by the various embodiments of the process for the production of an engineered wood product having certain desired properties by providing logs, sorting logs dependent on their properties into N piles of sorted logs. N can be a whole number equal to or greater than two.

The process continues by cutting logs from at least one of the piles of sorted logs into strands. This cutting process can be done independently on the piles of sorted logs, that is, strands can be cut from logs from only one of the piles at a time. The sizing of strands refers to the cutting or sawing of wood logs into appropriately dimension controlled strands or flakes. Typically, some logs from more than one pile of sorted logs can be cut into strands. Strands from different piles of sorted logs generally will not be mixed together at this stage.

The cut strands can then be sorted, dependent on strand properties, into S groups of strands. S can be a whole number equal to or greater than two. The separation point, or points, for the properties used to divide the strands into groups can vary and be set depending on the requirements of the final products. For strands produced from different piles of sorted logs, S can be the same or different.

The strands can then be combined with strands from one or more groups of strands, dependent on the desired properties of the resulting engineered wood product, to form combined strands, and resin can be applied to the combined strands to form resinated combined strands, or alternatively, the strand combining and resin applying steps can be reversed. In the strand combining operation, strands originating from different piles of sorted logs can be combined together. In either case, the resinated combined strands can be oriented and formed into mats, which can be further processed by known methods to produce the final desired engineered wood product with the desired properties.

The process according to the present teachings can use various log properties as a basis for sorting logs including at least one member selected from the group consisting of species, density, modulus of elasticity, moisture content and log diameter.

Sorting of the logs can be accomplished by visual observation and measurement followed by separation into at least two piles, for instance, logs suitable for OSL and LSL in one pile and another pile containing logs not suitable for OSL and LSL. Handheld ultrasonic devices can also be used to measure the density of the logs and group them into groups based on density. Other log properties can be measured as desired and used to further classify the logs.

In some embodiments of the present teachings, sorting of the logs can be a two-stage, three-stage, or more sorting process where the logs are sorted on the basis of one property in a first stage, then sorted into subsets based on another different property and so forth.

The process according to the present teachings can, in various embodiments, cut logs into two-dimensional (“2D”) strands only, three-dimensional (“3D”) strands only, or into a combination of 2D and 3D strands. A 2D stranding process controls both the length and the thickness of the strands produced. A 3D stranding process controls all three dimensions of length, thickness and width of the strands.

The various embodiments of the present teachings can create suitable strands in any of a variety of known methods, including, for instance, the Timberstrand® process, (from Trus Joist, a Weyerhauser Business of Boise, Id.), a 2D stranding process where logs are first stranded based on length and thickness with scoring knives and projected knives while counter knives control the width of the strands. The resulting strands have randomly distributed widths. Extensive screening operations are currently applied to obtain desirable strand sizes for the making of LSL, for example. Preferred strand sizes for LSL include, for instance, strands with length greater than or equal to about 8″, width greater than or equal to about 0.25″ and thickness less than about 0.05″, preferably about 0.03″.

An example of a 3D stranding process that can be utilized in the present teachings is described in U.S. Pat. No. 6,035,910, and is a veneer strip manufacturing process providing strands with uniform length, width, and thickness. The stranding process begins by (a) cutting logs into boards with a uniform thickness corresponding to the predetermined width of the strands, the predetermined width being transverse to the fiber of the veneer strips to be produced, (b) clamping the boards together, and (c) machining the clamped boards to form the veneer strips. These 2D and 3D stranders can be custom built by various strander manufacturers, including, Pallmann Maschinenfabrik GmbH & Co. KG, Zweibrucken, Germany and Carmanah Design and Manufacturing Inc., Vancouver, British Columbia, Canada.

The present process can further include drying the strands before sorting the strands. Drying the strands can occur in, for instance, a heated tumble dryer, a trip-pass dryer, or a drying tunnel. The tumble dryer can be a single-pass or multiple-pass dryer.

According to the present teachings, the criteria used as the basis for sorting the strands can include, for example, various strand properties, such as length, width, thickness, density, screen mesh size and modulus of elasticity. The presently taught processes can utilize a variety of known methods for sorting strands including, for instance, those methods disclosed in U.S. Pat. Nos. 6,234,322; 5,012,933; and 5,109,988, EP1362643, EP1358020, EP1007227, EP0681895, WO2002/062493, and WO9840173. Additional sorting processes include the oscillating screen process and Quadradyn™ machine process both manufactured by PAL s.r.l. (Via delle Industrie, 6/B, 1-31047 Ponte di Piave (TV), Italy).

The present processes can further include the step of storing the sorted strands prior to either combining or applying resin to the strands. When the process according to present teachings includes strand storage such storage can be under environmentally controlled conditions to maintain the moisture content of the strands within a predetermined range. The environmentally controlled strand storage can be achieved in storage bins designed for such a purpose. In various embodiments of the present teachings, the predetermined range for the moisture content for both drying the strands and for the stored strands can range between about 3 percent and about 12 percent by weight.

Examples of suitable resins for the present process include, without limitation, 4,4′-diphenylmethane-diisocyanate. (“MDI”), melamine-urea-phenol-formaldehyde (“MUPF”), melamine-urea-formaldehyde (“MUF”), phenol-formaldehyde (“PF”), their copolymers, and mixtures thereof.

The resin can be any resin having properties sufficient to meet or exceed generally known standards for the desired grade of engineered wood product. For example, resins qualified for the manufacture of engineered wood products or structural composite lumber (“SCL”) products conforming to the applicable acceptance criteria as promulgated by building code authorities such as the International Code Council (“ICC”). Examples of such criteria include, for instance, the AC47 acceptance criteria for structural wood-based products. Further additional examples of acceptance criteria can be found at www.icc-es.org.

Additional compounds and additives, such as, for example, waxes, can be added during the resin addition process.

The various embodiments of the present teachings can be utilized to produce a variety of engineered wood product including oriented strand lumber, oriented strand board and laminated strand lumber. One of ordinary skill in the art will recognize that the present teachings are not limited to the named engineered wood products but can be utilized in any number of processes involving the processing of logs into strands, flakes, or any smaller wood particles and the sorting and selection of the strands, flakes, or smaller wood particles to produce an engineered wood product. Additionally, the present teachings can be applied to any type of wood resource, including, softwoods and hardwoods, for example.

The engineered wood products produced by the various embodiments of the present teachings can have a variety of their properties controlled by the present process. Those controlled properties can include, for example, MOE, modulus of rupture (“MOR”), surface characteristics, appearance, tension strength, shear strength and density. Directional-based properties such as modulus of elasticity including the edgewise MOE and the flatwise MOE can also be controlled by the present process.

With the process according to the present teachings, the modulus of elasticity of the engineered wood products can be controlled to be within certain predetermined ranges, for example, an MOE range of between about 0.8 and about 2.5, or between about 0.8 and about 1.3, or between about 1.3 and about 1.7, or between about 1.7 and about 2.0, or between about 2.0 and about 2.5. The intended use of the engineered wood product can be a factor in determining the desired MOE range.

According to the present process, a variety of engineered wood products having differing desired properties including, for example, oriented strand lumber, oriented strand board and laminated strand lumber can be, according to the present teachings, produced on the same engineered wood product production line. In order to obtain such production capability moderate changes may need to be made to the production line.

According to the present teachings, the desired MOE of a final oriented strand product can be controlled by varying the ratio of the strands used. Table I below illustrates suggested ratios of long strands, about 4.5″ long to about 7.125″ long, and short strands, less than about 4.5″ and more than about 3.0″ long, to produce oriented strand product with a nominal thickness of 1.75″ with varying levels of MOE as desired.

TABLE 1

| MOE (mmpsi) | Density (lb/cu. ft) | % Long Strand | % Short Strand |
|---|---|---|---|
| 2.1 | 45 | 99.5 | 0.5 |
| 2.0 | 43 | 100.0 | 0.0 |
| 1.9 | 42 | 96.9 | 3.1 |
| 1.8 | 41 | 94.9 | 5.1 |
| 1.7 | 40 | 91.7 | 8.3 |
| 1.6 | 39 | 88.8 | 11.2 |
| 1.5 | 38.5 | 86.0 | 14.0 |

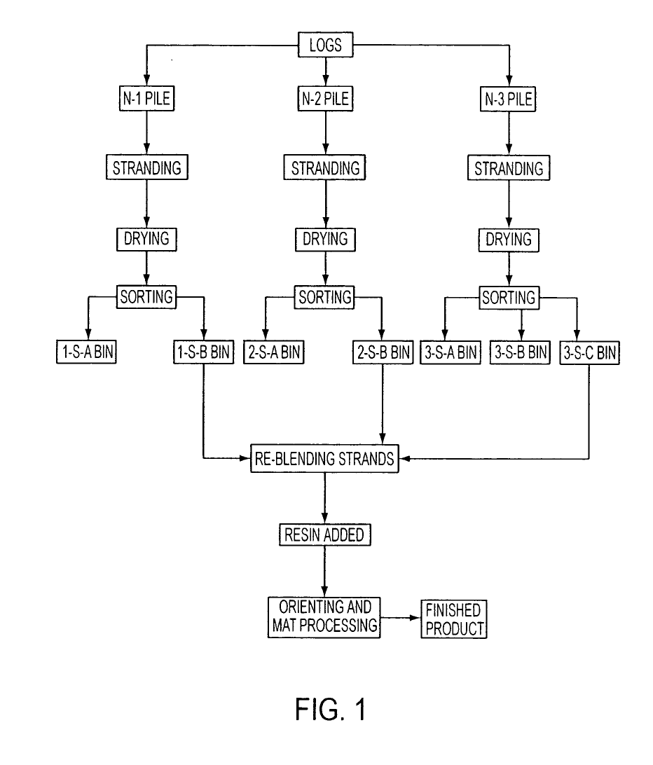

One embodiment of the present teachings is illustrated in FIG. 1, several of the steps of the process include (1) logs are sorted based upon, for instance, their diameters, species and density and stored in three separate piles in a log yard; (2) sorted logs are then sized into strands through a strander; (3) strands are then dried with a dryer to a desired level of moisture; (4) dried strands are then screened and divided into three or more bins based on strand dimensions and qualities; (5) based on the desired properties of the end product, strands are then re-blended from bins with blending means; (6) re-blended strands are resinated; (7) resinated strands are aligned into mats with usual orientating means such as an orientating disk; (8) the loosely packed mats are then heat-pressed to desirable thickness with the appropriate compaction ratio; (9) the resulting product can then go through the usual finishing steps, such as, trimming, cutting, stamping, sanding, edge treating, packaging, and so forth.

In other embodiments of the present teachings, the screening and drying steps set forth in FIG. 1 can be performed in the opposite order. Additionally, the re-blending and resinating steps can also be performed in the opposite order. One of ordinary skill in the art will recognize numerous other process variations within the scope of the present teachings.

All publications, articles, papers, patents, patent publications, and other references cited herein are hereby incorporated herein in their entireties for all purposes.

Although the foregoing description is directed to the preferred embodiments of the present teachings, it is noted that other variations and modifications will be apparent to those skilled in the art, and which may be made without departing from the spirit or scope of the present teachings.

The following examples are presented to provide a more complete understanding of the present teachings. The specific techniques, conditions, materials, and reported data set forth to illustrate the principles of the present teachings are exemplary and should not be construed as limiting the scope of the present teachings.

### EXAMPLE

Southern yellow pine (“SYP”) logs were processed into strands with target length of 7.125″, thickness of 0.030″ and width of 0.75″ using a commercially available ring strander. The strands were then dried to a target moisture content of about 3% to about 6%. The dried strands were then screened with a disk screener. The approximate recovery rate for long strands from the screened SYP furnishes was about 50%, about 47% for short strands, and about 3% as fuel and waste for disposal. Polymeric MDI resin (available from Huntsman ICI), 5.5 wt. %, and emulsion wax (available from Borden Chemicals), 1.5 wt. %, were applied to the screened SYP strands. Selected ratios of the resinated strands were then feed to an orienting station to align the majority of the strands primarily along the strand length. Following a two-step pre-heating/hot pressing schedule, the formed mats were pressed with a 4′ by 8′ steam injected hot press to a final target thickness of the final oriented strand product of 1.75″. The screened long strand portion was used to make the middle tier single layered engineered wood product with a relatively high MOE, and the short strand portion was used to make regular lower MOE products.

The foregoing detailed description of the various embodiments of the present teachings has been provided for the purposes of illustration and description. It is not intended to be exhaustive or to limit the present teachings to the precise embodiments disclosed. Many modifications and variations will be apparent to practitioners skilled in this art. The embodiments were chosen and described in order to best explain the principles of the present teachings and their practical application, thereby enabling others skilled in the art to understand the present teachings for various embodiments and with various modifications as are suited to the particular use contemplated. It is intended that the scope of the present teachings be defined by the following claims and their equivalents.

What we claim is:

1. A process for the production of an engineered wood product having certain desired properties comprising:
providing logs;
sorting logs dependent on their properties into N piles of sorted logs;
cutting logs from at least one of the piles of sorted logs into strands;
separately sorting the strands, produced from each cutting operation, dependent on strand properties into S groups of strands; then either
combining strands from one or more groups of strands dependent on the desired properties of the resulting engineered wood product to form combined strands, and
applying resin to the combined strands to form resinated combined strands,
or
applying resin to strands from one or more groups of strands to form resinated strands, and
combining resinated strands dependent on the desired properties of the resulting engineered wood product to form resinated combined strands;
then
orienting the resinated combined strands into mats; and
finishing the mats into an engineered wood product having the desired properties, and
wherein N is two or more, S is two or more, and strands originating from different piles of sorted logs can be combined together.

2. The process according to claim 1, wherein the properties of the logs used as a basis for sorting logs comprise at least one member selected from the group consisting of species, density, modulus of elasticity, moisture content and log diameter.

3. The process according to claim 1, wherein the logs are cut into 2D strands only, 3D strands only, or into a combination of 2D and 3D strands.

4. The process according to claim 1 further comprising:
drying the strands before sorting the strands.

5. The process according to claim 1, wherein the properties of the strands used as a basis for sorting strands comprise at least one member selected from the group consisting of length, width, thickness, density, moisture content, screen mesh size and modulus of elasticity.

6. The process according to claim 1 further comprising:
storing the sorted strands prior to either combining or applying resin to the strands.

7. The process according to claim 6, wherein the strands are stored under environmentally controlled conditions to maintain the moisture content of the strands within a predetermined range.

8. The process according to claim 7, wherein the predetermined range for the moisture content of the strands ranges between about 3 percent and about 12 percent by weight.

9. The process according to claim 1, wherein the resin comprises at least one member selected from the group consisting of 4,4′-diphenylmethane-diisocyanate, melamine-urea-phenol-formaldehyde, melamine-urea-formaldehyde, phenol-formaldehyde, their copolymers and mixtures thereof.

10. The process according to claim 1, wherein the desired engineered wood product comprises one member selected from the group consisting of oriented strand lumber, oriented strand board and laminated strand lumber.

11. The process according to claim 1, wherein the desired properties of the resulting engineered wood product comprise at least one member selected from the group consisting of modulus of elasticity, edgewise modulus of elasticity, flatwise modulus of elasticity, modulus of rupture, surface characteristics, appearance, tension strength, shear strength and density.

12. The process according to claim 1 wherein the modulus of elasticity of the engineered wood product ranges between about 0.8 and about 2.5.

13. The process according to claim 11, wherein the modulus of elasticity of the engineered wood product ranges between about 0.8 and about 1.3.

14. The process according to claim 11, wherein the modulus of elasticity of the engineered wood product ranges between about 1.3 and about 1.7.

15. The process according to claim 11, wherein the modulus of elasticity of the engineered wood product ranges between about 1.7 and about 2.0.

16. The process according to claim 11, wherein the modulus of elasticity of the engineered wood product ranges between about 2.0 and about 2.5.

17. The process according to claim 1, wherein engineered wood products having differing desired properties are produced on the same engineered wood product production line.

18. A process for the production of engineered wood products comprising:
providing logs;
sorting logs dependent on their properties into N or more piles of sorted logs;
independently cutting logs from at least one of the piles of sorted logs into strands;
sorting the strands dependent on strand properties into S or more groups of strands;
combining strands from one or more groups of strands dependent on the desired properties of the resulting engineered wood product;
applying resin to the combined strands to form resinated combined strands;
orienting the resinated combined strands into mats; and
finishing the mats into the desired engineered wood product, and
wherein the desired engineered wood products have differing sets of properties, are produced on the same engineered wood product production line, N is a whole number of two or greater, and S is a whole number of two or greater.

19. A process for the production of engineered wood products comprising:
a log sorting and strand production process comprising:
providing logs;
sorting logs dependent on their properties into N or more piles of sorted logs;
independently cutting logs from each one of the piles of sorted logs into strands;
sorting the strands dependent on strand properties into S or more groups of strands,
and
an engineered wood product production process comprising:
combining strands from one or more groups of strands dependent on the desired properties of the resulting engineered wood product;
applying resin to the combined strands to form resinated combined strands;
orienting the resinated combined strands into mats; and
finishing the mats into the desired engineered wood product,
and
wherein the desired engineered wood products have differing properties and are produced on the same production line,
N is a whole number of two or greater, and S is a whole number of two or greater.
